(19) United States
(12) Patent Application Publication
(10) Pub. No.: US 2010/0052263 A1
(43) Pub. Date: Mar. 4, 2010

(54) ELECTROPLATED RESILIENT SEAL

(75) Inventor: JAMES C. DOANE, FRIENDSWOOD, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 12/203,316

(22) Filed: Sep. 3, 2008

(51) Int. Cl. F16J 15/32; B23P 15/00

(52) U.S. Cl. 277/404; 29/460

(57) ABSTRACT

A seal includes a resilient material and a metallic material electroplated to the resilient material and a method for making an extrusion resistant seal including electroplating a resilient seal material.

### BACKGROUND

In the hydrocarbon recovery industry, seals are used ubiquitously to isolate certain tools or wellbore sections from other tools, wellbore sections, fluids, etc. Seals are also well used for holding pressure at various locations within a well system. Seals employed for the duties noted and others comprise many different types of materials depending upon the application for which they are intended to be put. In some cases metal-to-metal seals are best suited to the task. Metal seals have as one of their benefits that they are inherently nonextrudable. In many applications though, a greater resiliency is needed than metal or other harder material can provide. In such cases elastomeric seals might be selected. Elastomeric seals have exceptional resiliency and have proven themselves in the downhole environment in many forms such as, for example, O-rings. Elastomeric seal do however, suffer from a reduced ability to withstand extrusion forces. For this reason, many configurations have been devised that “back-up” the elastomeric seals in an attempt to frustrate extrusion processes. Since such back-up configurations rarely can be constructed to completely eliminate a gap between the sealed structures, extrusion remains a challenge in many applications.

### SUMMARY

A seal includes a resilient material and a metallic material electroplated to the resilient material.

A method for making an extrusion resistant seal including electroplating a resilient seal material.

### BRIEF DESCRIPTION OF THE DRAWINGS

Referring now to the drawings wherein like elements are numbered alike in the several Figures:

FIG. 1 is a perspective half section view of an O-ring in accordance with this disclosure.

### DETAILED DESCRIPTION

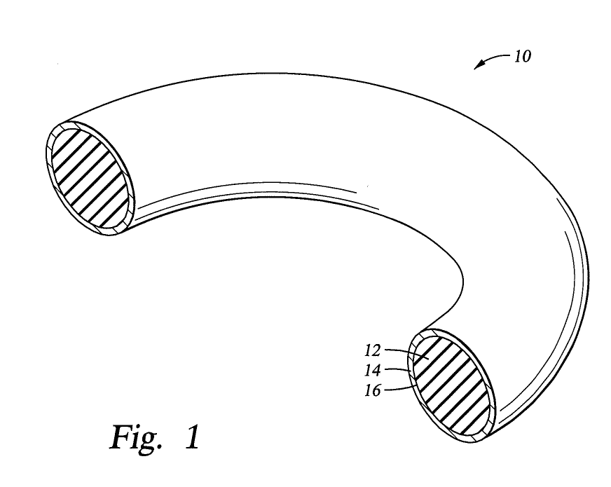

Referring to FIG. 1, a seal 10 is illustrated as one embodiment of a metal coated elastomeric seal, such as nitrile rubber (NBR) and hydrogenated nitrile rubbers (HNBR), Fluorinated elastomers (FKM), Perfluoro elastomers (FFKM), Ethylene Propylene Diene Monomer rubbers (EPDM), etc. (or other soft material that would be subject to extrusion during use) according to the teaching herein. It is to be appreciated that a resilient material (e.g. elastomeric) O-ring is primarily addressed herein for simplicity in discussion rather than any limitation. The process and resulting product is rather directed to a generic level of soft extrudable material coated with a metal coating to enhance extrusion resistance and configured to function as a seal.

Still referring to FIG. 1, seal 10 comprises a resilient material 12, which may be elastomeric (or other extrudable material as noted). Further, the resilient material 12 is coated in a metal material 14 that is directly adhered to a surface 16 of the material 12. In one embodiment the coating is electroplated on the material 12. In order for an electroplating process to be utilized, the base material upon which the metal is to be plated must be conductive ab initio or rendered conductive. Rendering the material 12 conductive in one embodiment occurs just prior to application of a plating process.

In one embodiment of the seal 10 described herein, the material 12 is a nonconductive elastomeric material. The material is then subjected to a conductive coating process. One such process is that commercially available from Flexbrite Inc., Houston Tex. where a film of conductive coating material is applied to the material 12 rendering that material capable of accepting a metal plating. Caswell Inc., Lyons NY makes other processes and products commercially available, such as Silvaspray™ that may be substituted. Whether one of these processes or products is used on a nonconductive material 12 or the material 12 is already conductive, such as NBR, HNBR, FKM, FFKM or EPDM as noted above but in a form that has been commercially rendered conductive. These materials are generally used as EMI shielded elastomers. The material 12 whether conductive or conductively coated is ready for electroplating. Electroplating is effected with a suitable metal such as gold, Silver, or other soft ductile metal, for example through a commercially known process including those of either of Flexbrite, Inc. and Caswell, Inc.

It has been found by the present inventor that a plating thickness ranging from about 0.005 inch to about 0.025 inch is sufficient to provide the structural properties of containing the resilient material 12 without splitting the metal plating. In addition, the metallic plate 14 is a complete uninterrupted layer of metal surrounding the material 12. There are therefore, no holes, discontinuities, etc. that could degrade the containing power of the plating material 14.

The resilient seal 10 provides all of the resilience of an art recognized O-ring, annular seal, packer, etc. for example, yet exhibits a much greater resistance to extrusion in use.

While preferred embodiments have been shown and described, modifications and substitutions may be made thereto without departing from the spirit and scope of the invention. Accordingly, it is to be understood that the present invention has been described by way of illustrations and not limitation.

1. A seal comprising:
a resilient material;
a metallic material electroplated to the resilient material.

2. The seal as claimed in claim 1 wherein the resilient material is elastomeric material.

3. The seal as claimed in claim 1 wherein the resilient material is at least one of NBR, HNBR, FKM, FFKM or EPDM.

4. The seal as claimed in claim 1 wherein the resilient material is electrically conductive.

5. The seal as claimed in claim 4 wherein the electrically conductive material is of NBR, HNBR, FKM, FFKM or EPDM.

6. A method for making an extrusion resistant seal comprising electroplating a resilient seal material.

7. The method as claimed in claim 6 wherein the electroplating further includes conductively coating the resilient material prior to electroplating.

8. The method as claimed in claim 6 wherein the electroplating is to a thickness of greater than about 0.005 inch.

9. The method as claimed in claim 6 wherein the electroplating is to a thickness of less than about 0.025 inch.
